(19) United States
(12) Patent Application Publication
(10) Pub. No.: US 2010/0138480 A1
(43) Pub. Date: Jun. 3, 2010

(54) Method and system for providing content over a network

(76) Inventor: D'ANDREA BENEDETTO, NEW YORK, NY (US)

Correspondence Address: DLA PIPER LLP US, P. O. BOX 2758, RESTON, VA, 20195, US

(21) Appl. No.: 12/591,455

(22) Filed: Nov. 19, 2009

Related U.S. Application Data
(60) Provisional application No. 61/117,844, filed on Nov. 25, 2008.

(51) Int. Cl. G06F 15/16; H04N 7/18

(52) U.S. Cl. 709/203; 709/219; 348/157; 348/E07.085

(57) ABSTRACT

A computerized system and method for providing access to a live event over a network, comprising: receiving by a server, over the network, a request to access the live event from a user utilizing a device; providing by the server, over the network, at least two different camera position views of the requested live event to the user utilizing the device; receiving by the server, over the network, a request to access at least one of the at least two different camera position views of the requested live event from the user; and providing the requested camera position view to the user utilizing the device.

### CROSS-REFERENCE TO RELATED APPLICATION

This application is based on and derives the benefit of the filing date of U.S. Provisional Patent Application No. 61/117,844, filed Nov. 25, 2008. The entire content of this application is herein incorporated by reference in its entirety.

### BRIEF DESCRIPTION OF THE FIGURES

FIG. 1 illustrates a system 100 of providing content to a user device 101 over a network 105, according to one embodiment.

FIG. 2 illustrates examples of a user device 101 that can access the system 100 through the user interface 125, according to one embodiment.

FIG. 3 illustrates details of server 110, according to one embodiment.

FIG. 4 illustrates a diagram showing how a user can access a digital source, according to one embodiment.

FIG. 5 is a diagram showing how a master authorization application 305 could work with local POP applications 315 accessing local content, according to one embodiment.

FIG. 6 illustrates a series of graphical user interface (GUI) Web pages that can be used by a user to access content, according to one embodiment.

FIG. 7 illustrates a method 700 of providing multimedia over a network, according to one embodiment.

FIG. 8 illustrates details of method 725, which allowing users to choose to view various camera angles captured by different cameras at various locations, according to one embodiment.

FIGS. 9-14 illustrate example GUI pages, according to several embodiments.

FIG. 15 illustrates details of data management application 310, according to one embodiment.

### DETAILED DESCRIPTION OF EMBODIMENTS OF THE INVENTION

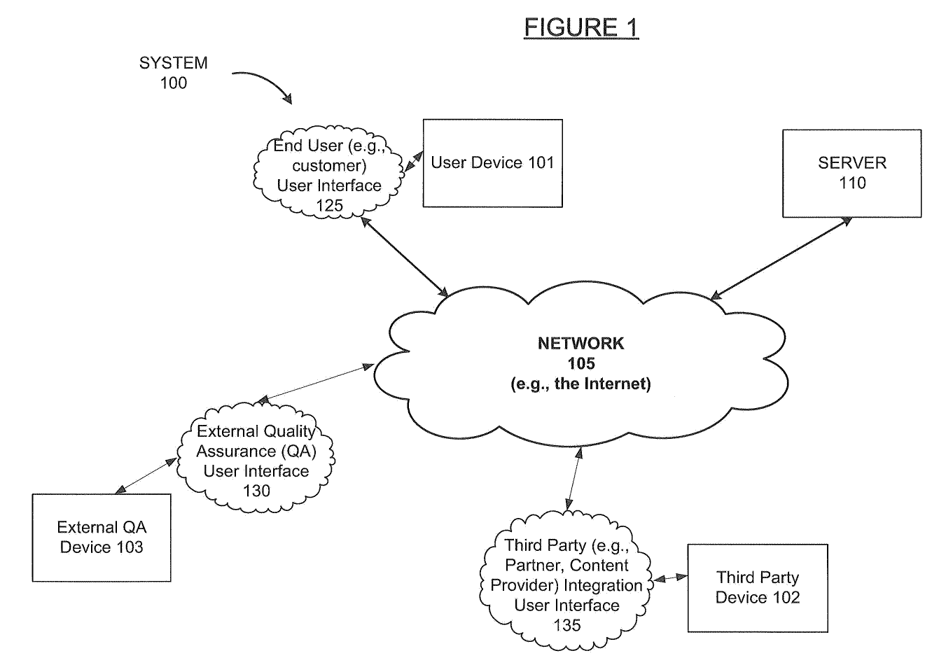

FIG. 1 illustrates a system 100 of providing content to a user device 101 over a network 105, according to one embodiment. The system 100 can manage and administer distribution of content to users. The system 100 can comprise a network 105 that connects a server 110 with a user interface 125 and a third party integration user interface 135. The third party integration user interface 135, which can be accessed using a third party device 102, can include a partner, content provider, advertiser, social network (e.g., supporting distribution or acquisition of content to inject in products), chat network (e.g., Instant Messaging), widget network, or any other third party (e.g., outside vendors completing and/or authorizing a specific transaction). Note that the account authorization of a third party could be used to access system 100. A wide variety of third parties may be integrated in the system 100 as a wide variety of products and services, both recorded and live, are provided to customers. For example, a content provider can access the third party integration user interface 135 in order to connect to the server 110 in order to manage content (e.g., wallpaper, ringtone, application). For example, a content provider can allow access to see many different views of a particular concert.

In one embodiment, an external quality assurance (QA) user interface 130 can allow the server 110 to link to third party QA services. These QA services can test products and/or services before they are sold. Products can include Web products and/or services, application products and/or services, and data manipulation products and/or services.

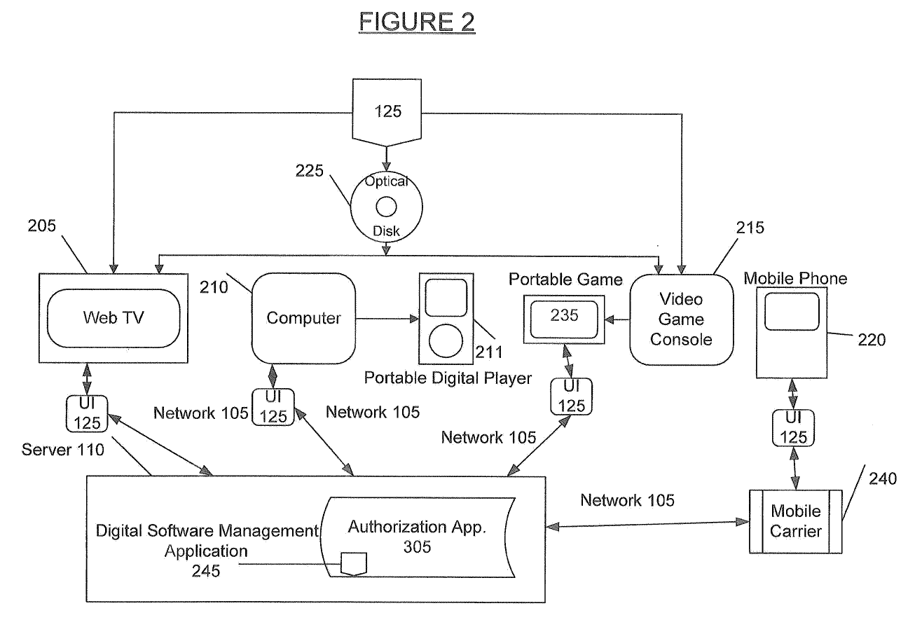

In one embodiment, a user (e.g., customer) can access the user interface 125 in order to connect to the server 110 to access content stored on the server 100, which is provided by the content provider. In another embodiment, a user can access the user interface 125 in order to connect to the server 110 to obtain authorization to access content stored at another source. For example, a user can access the user interface 125 on a user device 101 such as a telephone or computer to view a particular concert and to choose several views of that particular concert. The views can include, for example, various stage position views, a backstage view, a dressing room view, etc. The network 105 can include the Internet and/or or one or more intranets (e.g., a computer network, a telephone network). The user interface 125 can be accessed by a user device 101 (described in more detail with respect to FIG. 2) used by one or more entities (e.g., an individual, family, or other group) who wish to access and/or purchase content.

The content can include, but is not limited to: music, video, concerts, sports events, multi-player games, theater (e.g., Broadway shows), lectures, written material, or advertising, or any combination thereof. For example, an individual, family, or other group may wish to view a concert of a particular band or a sports event held in the past and/or present. In addition, access to a future concert or sports event can be bought by paying for the access (e.g., virtual access, physical access) before the concert is aired. An entity that wishes to provide or facilitate providing content (e.g., an individual, a band, a sports team, a sports organization) can utilize the content provider device 102 (these can include the same type of devices discussed with respect to the user device 101) to access the network through a content provider interface 120 in order to provide the content (e.g., to add content on server 110). The client interface 120 can be accessed by one or more entities that are affiliated with an artist, a band, a record label, a sports team, a sports organization, an entertainment event (e.g., a concert, a sports event), or any other content provider organization. For example, a brand or marketing manager for a particular band could access the client interface 120 in order to manage the content and options that are accessible to users. In one embodiment, marketing can be updated and customized to each user at any point, and at any time.

FIG. 2 illustrates examples of a user device 101 that can access the system 100 through the user interface 125. The user device 101 can include, but is not limited to: a television (e.g., using Web TV 205), a computer 210 (e.g., a personal computer or a handheld computer, such as, for example, a portable digital player 211), a video game console 215 (that can run, for example, a portable game 235), a mobile phone 220, a personal digital assistant (PDA) (which can be synchronized with a remote server to download content to the PDA for later consumption), or any other device, including devices that can access the Internet (e.g., Blue Ray live, which allows a Blue Ray device to use an Internet connection to download content tied to a Blue Ray DVD), or any combination thereof. The content can be a real-time digital or analog stream and/or can be formatted for distribution onto multiple media delivery platforms (e.g., downloadable digital software applications, CD/DVD/Blue Ray disks, smart cards, SDRAM memory chips, and secure Web links on server(s)). As shown in FIG. 2, in some embodiments, a user can access the server 110 (which can, e.g., allow access to content) by launching and initiating the user interface 125, which can be accessed through, for example, the Web TV 205, the computer 210, or the video game console 215. In one embodiment, the user can utilize an optical disk 225 in order to gain an access/identification code or address which enables the user to utilize the user interface 125 that can access the server 110. For example, an optical disk 225, when placed in the user device 101, could initiate an authentication through network 105 with server 110. Upon server 110 authentication, the user device 101 would receive content from the server 110 over the network 105. The mobile phone 220 can communicate with server 110 to access content through the mobile phone carrier 240. Those of ordinary skill in the art will also see that a non-mobile phone carrier and a non-mobile phone can also be used. All of the user devices 101 described above can be used with access control technology so that access to any content can be controlled. For example, an authorization application 305, which can reside on server 110, can grant access to requesting users by issuing an access code to the requesting user if the user has met certain conditions (e.g., paid for the content, provided a code indicating content should be provided, asked for content that is free (note that in alternative embodiments, free content can simply not require an access code)). Once the access code has been set up, the user can use the access code to request content. For example, a user could enter the access code into an electronic form on a Web page. As another example, the code could be discreetly embedded in a software application which authenticates with a remote server automatically whenever the software application is launched by a user. A digital software management application can then manage the content provided. Thus, for example, a unique personal identification code (PID) could be embedded on each physical disk and/or digital application (e.g., DC, DVD, Blue Ray DVD, online/mobile applications) owned and/or utilized by the user. In this manner, a user can view and experience his/her customized media content across all of his/her digital devices. In addition, live menus of products and/or services can be established, customized, personalized, and/or expired. In one embodiment, a unified billing account can be used for all transactions.

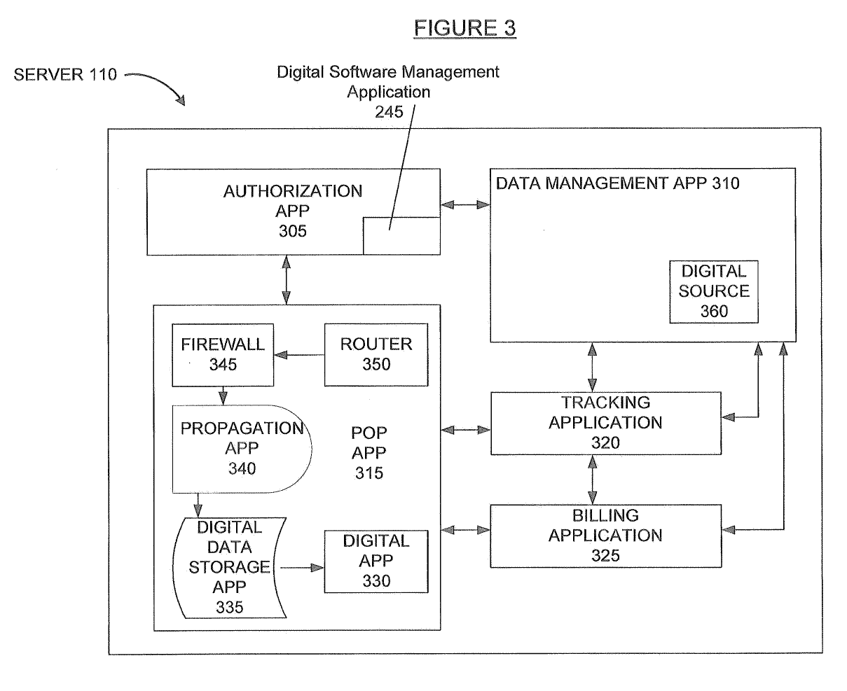

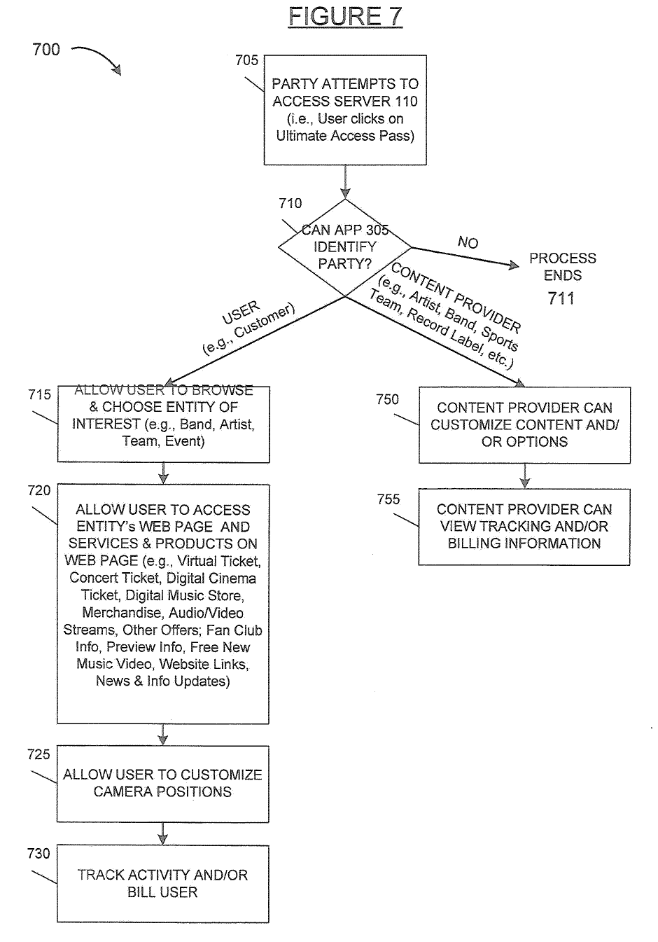

FIG. 3 illustrates details of server 110, according to one embodiment. Note that, while the applications, etc., are presented in FIG. 3 as being part of server 110, those of ordinary skill in the art will see that any or all of these applications, etc., can reside separate from server 110, and can still be accessed by server 110. For example, any of the applications could reside on a different server than server 110 and could be accessed over network 105. Server 110 can include an authorization application 305, a data management application 310, and a point of publication (POP) application 315. The authorization application 305 authenticates entities who attempt to access server 110. For example, a user could login to the server 110 using the authorization application 305 in order to be able to access content. The authorization application 305 could determine which content the user can access. As another example, a content provider could login to the server 110 using the authorization application 305 in order to manage the content provider's content (also explained in more detail in FIG. 7 and the accompanying explanation). As an additional example, an administrative person could login to the server 110 in order to access and/or manage the server 110. The digital software management application 245 can reside with the authorization application 305 as shown in FIGS. 2 and 3.

The data management application 310 can allow content providers to access and/or manage their content (e.g., a digital source). For example, the data management application 310 could allow content providers to view which of their content is available to users and/or which users are accessing their content. In addition, content providers could add or delete content, view and/or add new features to their content. The data management application 310 can operate through a series of user or software application-initiated commands, implemented through the content provider interface 120 and/or the content provide device 102 depending on user type and authentication.

For example, if the content provider is a music artist, the artist could give certain fans direct access to the artist's archives and content library. The artist could provide all digital music for purchase exclusively through the artist's Web site. In this way, the artist can control the content and the integrity of the content, while having the ability to offer marketing opportunities in a fluid, respective, and elegant manner.

One example of a service an artist could provide is that of a digital store that could be created specific to the artist. The digital store could allow consumers to purchase some or all of the artist's current live music/video, music/videos and catalog music/videos direct from an existing fan site. Outtakes or draft releases can be included in the store. Access to the digital store could or could not require a monthly subscription fee. In some embodiments, users who paid a subscription fee would receive additional content and incentives. The following products are examples of what could be offered via the digital store: a la carte singles downloads; products for users to use to customize their computers and mobile phones; full video downloads; ringtone downloads; full album downloads; or bundled products; or any combination thereof.

Another example of a service an artist could provide is that of a channel, which could include a music channel, video channel, or artist archive, or any combination thereof. Different tier membership services could be offered for different prices. For example, a Tier 1 membership could allow general admission to the music channel and video channel. A Tier 2 membership could allow front row admission to the video channel, as well as access to the music channel. A Tier 3 membership could allow full access to the music channel and video channel, as well as access to the artist archive. To entice members to join the channel or club, an introductory tier could be offered when members buy a particular product (e.g., one of the artist's albums). Different services could be offered at the different levels of membership service, including, but not limited to: access to audio and video outtakes, photos, interviews, full album streams, recording session details (e.g., track sheets and studio layouts), lyrics, cover art, liner notes, photo and/or video “album yearbooks” relevant to a particular album, pop-up trivia (e.g., synched to the “album yearbook”), fan-to-fan chatting (e.g., while listening to the week's relevant song, video, or album), or VIP guest chatting with the artist and/or artist insiders (e.g., people who can shed new light on a song, video, or album), or any combination thereof. The pop-up trivia can be active, where trivia questions pop up on a screen during a song, video, or album, and fans can answer the question(s). The results and scoreboards can be available to the user. Questions can be related to photos, videos, lyrics, and/or personal information. In one embodiment, the pop-up trivia can be passive, and fans can see (but not answer) interesting trivia items pop up while viewing a song, video or album.

In addition, memorabilia auctions can be held on the channel, where limited edition releases and memorabilia (old and new) can be auctioned on the site. The auctions can be passive (e.g., similar to an e-Bay or English auction) or interactive (e.g., using interactive audio and/or video technology, a host can display and show an item, answer questions, and hype/market it).

Furthermore, an interactive talk show can be hosted, where fans can call in (e.g., via phone or video chat) to, for example, a daily, weekly or monthly talk show to share stories about the music, personal connections, the artist, politics, etc. A VIP interactive talk show can also be hosted, where the artist or a member of the artist's inner circle can host an interactive chat.

The channel could offer rewards for users. For example, there could be a “silver album” reward for one-month subscriptions, a “gold album” reward for a six month subscription, and a “platinum album” reward for a year-long subscription. The rewards could include products, plaques, electronic plaques, etc.

The channel could also offer users full unique and exclusive network programs scheduled at various dates and times during any given year that offer programs, such as, but not limited to, “the definitive making of Album “X”, wherein the user has unlimited streaming access to all relevant archival material.

An additional example of a service an artist could provide is that of a mobile social network, which can allow users to connect with other fans via enhanced methods (e.g., Twitter, “live Mobile”). This can help establish a dialogue among fans around the world. Utilizing a global positioning service (GPS), Users can opt-in and subscribe to allow the data management application 310 to help track fan whereabouts, enabling alerts to the fans to artist-specific events and opportunities, as well as historically related information relevant to a specific artist at various locations throughout the world where historical events occurred when the fan is in the direct vicinity. Alerts can be via communication blasts (e.g., to a user's mobile phone) when a fan is near and/or at a specific location. Thus, for example, if a fan is walking the streets of Liverpool, England, the fan could be sent an alert indicating that “this is where Paul McCartney first met John Lennon”. Further details could be provided regarding the exact spot where the event took place, and an additional alert could be sent indicating when the fan was at the exact spot. In addition, users who subscribe to this service could be alerted to related products available at various locations when the fan is in a certain vicinity. Related products can include:, re communication blasts, mobile discount coupons, ringtones, ringbacks, wallpaper, etc. (e.g., relevant to specific artists of interest). It should also be noted that users (e.g., fans) can indicate which type of alerts they would like to receive.

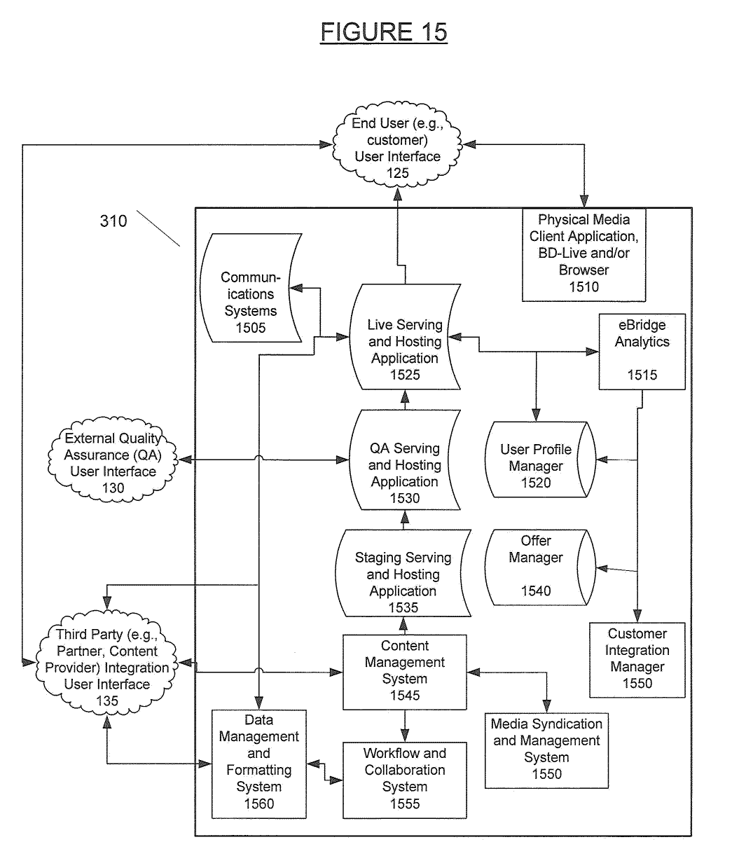

Details of the data management application 310 are illustrated in FIG. 15, according to one embodiment. Communications system 1505 can help provide two-way voice, video and text communications between arbitrary, authorized end users. A physical media client application, Blue Ray disk (BD) live and/or browser 1510 can be any end-user access device (e.g., PC, BD Player) accessing the system. A live serving and hosting application 1525 can handle incoming and outgoing data requests from end users. A QA serving and hosting application 1530 can test products prior to publishing. A staging serving and hosting application 1535 can produce a product prior to publishing. All serving and hosting applications 1525, 1530, and 1535 can include Web servers, application servers and data manipulation services.

A user profile manager 1520 can manage user profiles and all related information in data sources and application servers. Safe harbor certification can be provided using the user profile manager 1520. It can also connect to user profile data sources and establish relationships between shared users. An offer manager 1540 can establish and track various one-time codes, Blue Ray disk link codes, offers, discounts, revenue shares and other customer relationship management tasks required for completion and tracking of end user transactions. It can be auditable.

A content management system 1545 can manage and produce content, including live productions. A media synchronization and management system 1550 can prepare and produce audio and video content prior to injection into live products. A workflow and collaboration system 1555 can manage task tracking, production status data, and collaboration applications to facilitate communication between inside and outside production staff. A data management and formatting system 1560 can manipulate data sources (e.g., internal, customer, and third party) prior to publishing (e.g., preparation of data for display on any compatible user device 101). Output of data to customer systems can also be managed.

A virtual private network (VPN) or other set-up can be linked to an external QA user interface 130. In one embodiment, an integration layer can be added as a transition point between the system 100 and QA systems, third party systems (partners, content providers, advertisers, etc.), or end users, or any combination thereof. It should be noted that a wide variety of outside data sources can be coordinated together to access and share archived content and live operations.

Referring back to FIG. 3, the POP application 315 can allow users to access and/or manage content from the user end. For example, a user could view all of the content that is available and choose which content the user would like to access (e.g., access for free, to buy). The content that is available can be provided by the server 110, which can make available content from a content provider stored on the server 110, or the server 110 can facilitate access to content stored by the content provider, for example, on a content provider device 102. The POP application 315 can include a router 350, a firewall 345, a propagation application 340, a digital data storage application 335, and a digital application 330. The router 350 can be an intermediary device that expedites message delivery. The router can receive transmitted messages and forward them to their correct destination. The firewall 345 can be a security system designed to protect the system 100 against external threats, such as hackers. A firewall could also protect the user interface 125 and the content provider interface 120. In addition, specific content can be segregated from other content into safe harbor hosting environments.

Propagation of messages over different paths with different lengths can cause messages to appear at a user's computer with varying delivery times. The propagation process exists in order to more quickly and efficiently deliver requested content to a user and to take advantage of redundancy and error-handling inherent in network-based content delivery. The propagation application 340 can wait for all messages in a packet to appear and package them together. The digital data storage application 335 is a network-connected device used to house the elements which make up the user experience, which can include stored content libraries, user preferences, user viewing histories, billing and account histories, and marketing offers. The digital application 330 stores the executable software representing the business rules which assembles viewing experiences based on requests received from the user interface 125 and content provider interface 120 and responses to requests sent to the digital data storage application 335.

The server 110 can also include a tracking application 320 and/or a billing application 325. The tracking application 320 can track which content is being accessed and by who by creating database entries of output generated from all sent and received requests a user access code makes through the user interface 125. It can also track what features are being used and by whom in the same manner. For example, individual and aggregate user session data can be tracked by the tracking application 320 so the content provider can access this data from the content provider interface 120 and analyze how its content is being used. This information can be provided, for example, to the content provider and/or a third party provider of server 110, who can use this information to: optimize content availability, set pricing, generate unique marketing offers, target advertising, recommend users with similar interests, etc.

It should be noted that marketing can be done using, for example: known fans (e.g., from email lists, Web sites (e.g., message boards, fan sites), known influencers (e.g., to work on trivia and/or interactive shows and use them to market), publicity, discounts, free products, and/or other offers to users who recommend and/or invite friends. For example, in order to entice users to provide their information or their friends and/or family's information, products can be offered to the users (e.g., song streams, clips from an interactive album experience, video streams, opportunity to watch memorabilia auctions, concert (physical or virtual) ticket upgrades and backstage access, CD/DVD tour editions, pre-order opportunities).

It should also be noted that user accounts can be personalized. Such personalized user accounts may also be anonymous (e.g., identified only by a hash value, device ID, or IP address). The personalized accounts can create long term profiles that can be used to filter data back to one or more user devices 101 used to create the account. Personalization can include, for example, a list of badges representing levels of achievement or a list of movies a user has watched, which could be used to generate a customized list of trailers for delivery into, for example, a Blue Ray disk live experience. In addition, anonymous accounts can be transitioned to a non-anonymous account if a user chooses to opt into more invasive tracking and personalization features.

Personalization can also help control the ability of a user to obtain content. For example, a user may be able to download one copy of a movie every six months, or as many copies of a song as they want for one year. In addition, personalization can allow control of relationships between dates, content, and customers. For example, if a customer shows interest in action movies, when a new action movie is released, this movie could be accessed from Blockbuster by the customer on a specific date(s) with a 10% discount applied.

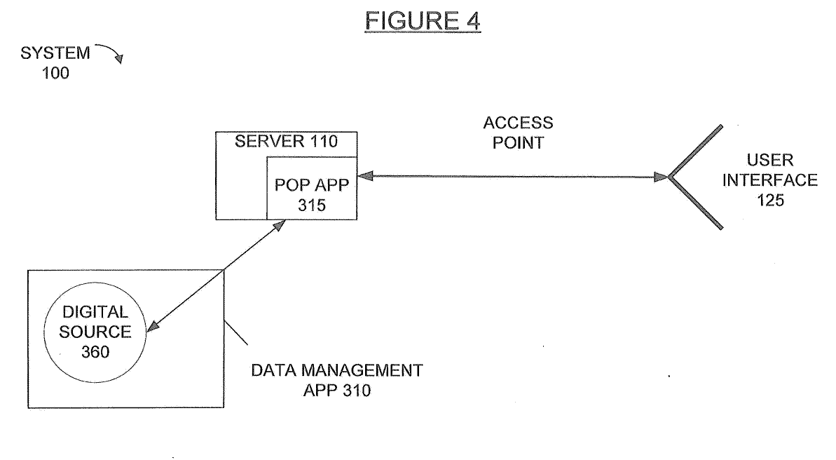

The billing application 325 can provide billing information to the users and content providers. For example, in one embodiment, the user can be billed through the POP application 315, and the content provider can be paid through the data management application 310. In other embodiments, information on billing the user can be provided through the POP application 315 and the data management application 310, but the user could pay the content provider directly, or through an intermediary other than a third party running server 110. The billing application 325 can work with the tracking application 320. For example, the tracking application 320 can track any access requested for content from a content list and can compute a payment rate for the source of the requested content in order to generate a payment statement to the source for access to the content. The authorization application 305 can include a content list and means for tracking any access requested for content and can compute a payment rate for the requested content. This can help generate a payment statement to the user for access to the content. A pricing table can be included and can have different pricing structures and different prices for different types of content handled by the system. Different pricing structures can include, but are not limited to: different prices for content accessed at different times (e.g., content accessed during prime time versus in the middle of the night, live content versus recorded content); different prices for different types of access to content (e.g., how many camera views the user is accessing, whether or not a user is inserting an avatar into content, whether or not a user is accessing a chat room); and different prices for content based upon demand for that content. For example, content that is live can cost more than content that is stored. FIG. 4 illustrates a diagram showing how a user can access a digital source, according to one embodiment. The user uses user interface 125 to identify the user with the authorization application 305, which, if appropriate, allows the user to access the POP application 315. The user can then use the POP application 315 to choose the content that the user would like to access (e.g., a digital source such as a concert or a sports event).

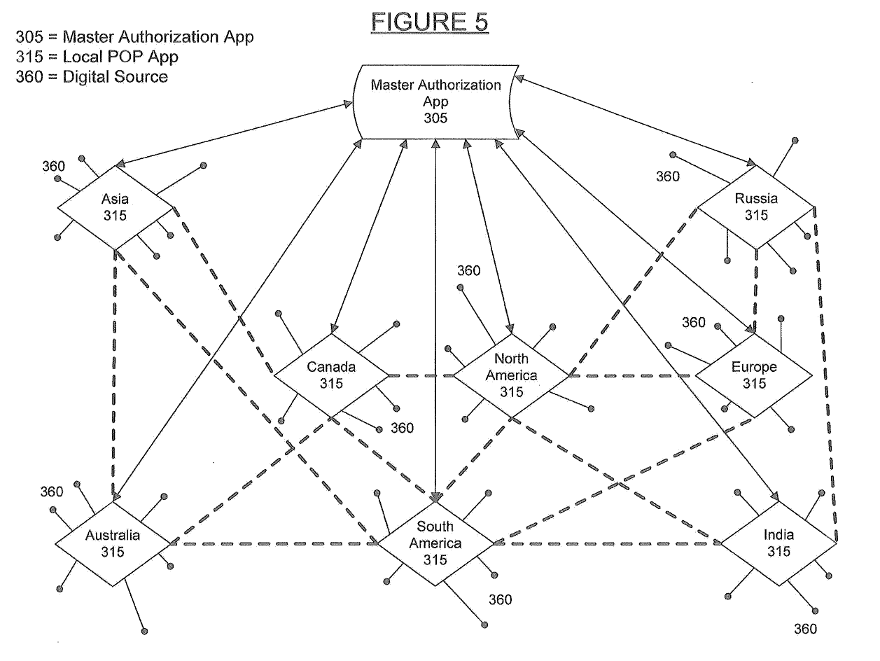

FIG. 5 is a diagram showing how a master authorization application 305 could work with local POP applications 315 accessing local content, according to one embodiment. In this example, the master authorization application 305 could allow a user access to system 100, and could direct the user to a location-appropriate POP application 315. The POP application 315 could allow the user to choose from local content (e.g., digital data) on a local data management application 310. In some embodiments, the local POP applications could be linked to a master POP application and/or the local data management application 310 could be linked to a master data management application 310.

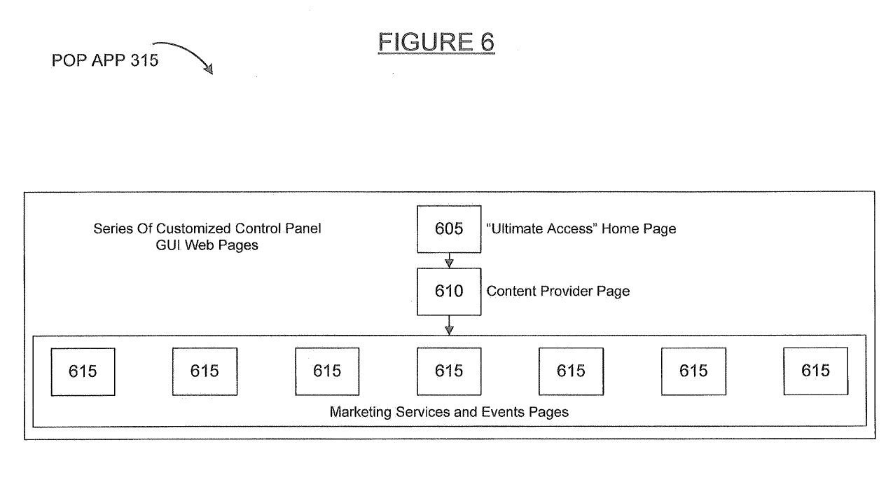

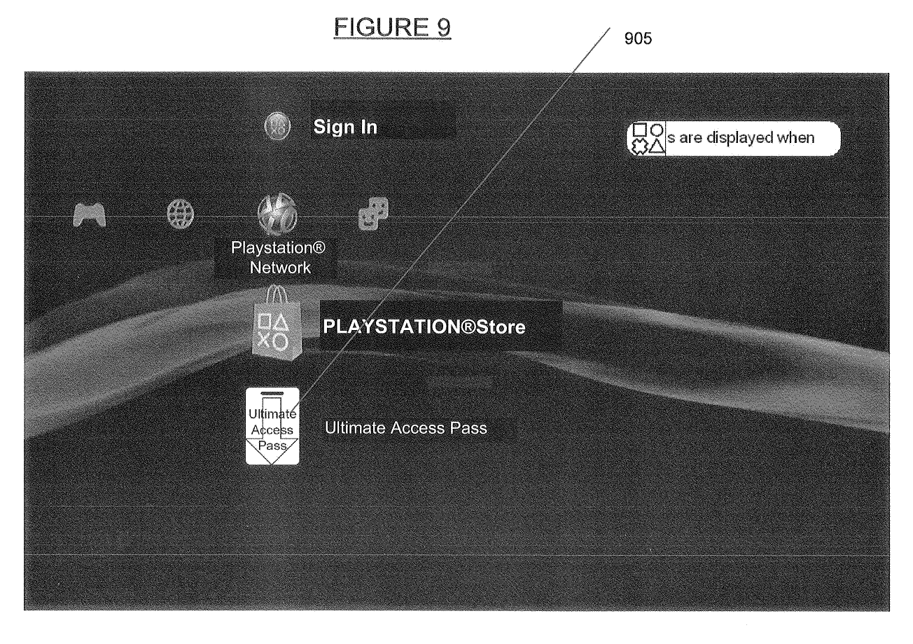

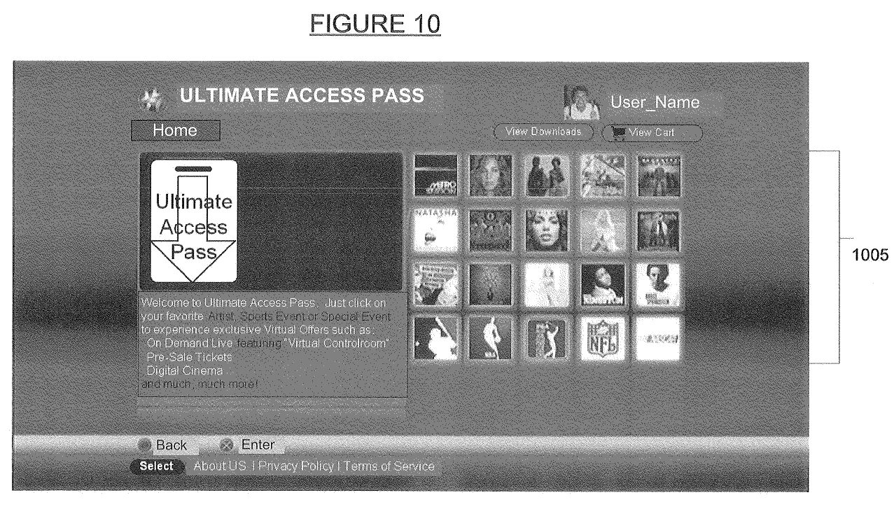

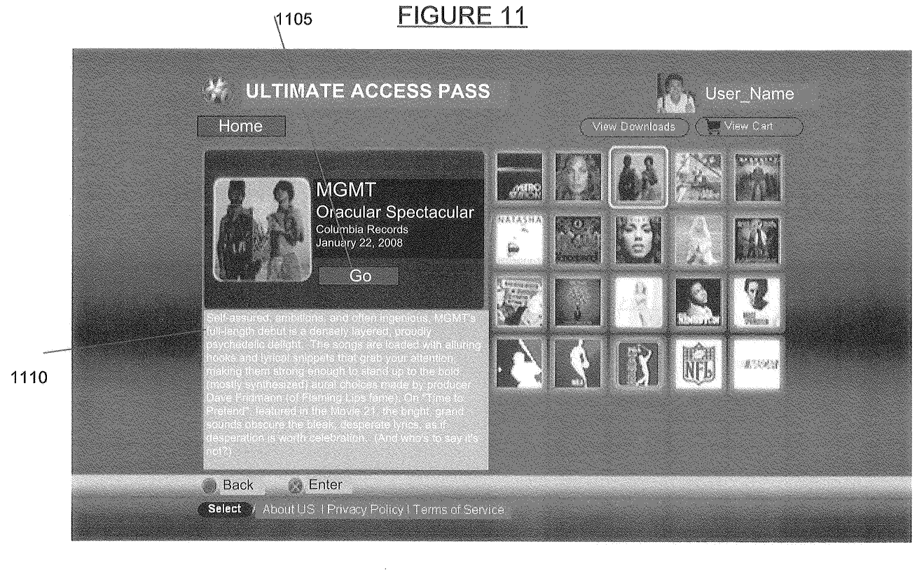

FIG. 6 illustrates a series of graphical user interface (GUI) Web pages that can be used by a user to access content, according to one embodiment. For example, a user could access POP application 315 through the home page 605 (e.g., an “Ultimate Access” home page, as shown on FIG. 10). The user could then be taken to the requested party's page in the content provider page 610. Thus, for example, if the user chose the band MGMT, the user would be taken to MGMT's page, as shown in FIG. 11. At this point, the user could view all of the marketing services and/or event pages 615 on MGMT's page. These could include current and past concerts, tickets (virtual or otherwise) to future concerts, and other features (described in more detail with respect to FIGS. 9-14, which illustrate example GUI Web pages).

FIG. 7 illustrates a method 700 of providing multimedia over a network, according to one embodiment. In 705, a party attempts to access server 110. For example, in FIG. 9, the user could click on the icon Ultimate Access Pass 905. In 710, it is determined if the authorization application 305 can identify the party. If not, in 711 the process ends.

If the authorization application 305 determines that the party is a content provider, the process moves to 750. In 750, the content provider can access the content provider's content to remove, edit or add content. In addition, the content provider can remove, edit, or add options to the content. Options include, but are not limited to: allowing the user to buy a particular concert or game (e.g., an old famous concert, an old famous sports game, a concert or game played earlier in the year, a concert or game the fan previously attended); allowing the user to buy a set or subset of concerts/sports games/etc. (e.g., an Ultimate Access Season Pass so that a fan can go “on tour” or “on the road” with the band/team/etc.); allowing the user to access special events (e.g., live Meet & Greet events, virtual Meet & Greet events, interviews, reporting); allowing a user to buy a song, video or other content (e.g., ring tones, ring back tones, DVDs, CDs) related to the concert/artist/band/team/etc.; allowing a user to join a fan club associated with the artist/band/team/etc. (e.g., a link could be provided to an official and/or non-official fan Web site); allowing a user to insert an avatar into a particular concert/game/event/etc.; allowing a user to buy merchandise related to a concert/artist/band/team/event/etc.; allowing a user to access news and information related to a concert/artist/band/team/event/etc.; or allowing a user to join a list serve; or any combination thereof. In 755, the content provider can access the tracking and/or billing information. For example, the content provider could: find the name, location, billing information, etc. of certain demographics of the users that bought or accessed particular available options; track information to determine how best to bundle content (e.g., an all-access pass to certain games, events, live and pre-recorded concerts); determine the length of time content was viewed or listened to; determine the number of concurrent users of any particular piece of content; and track what percentage of users from what user devices 101 (e.g., cell phone, PC, etc.) were accessing which options.

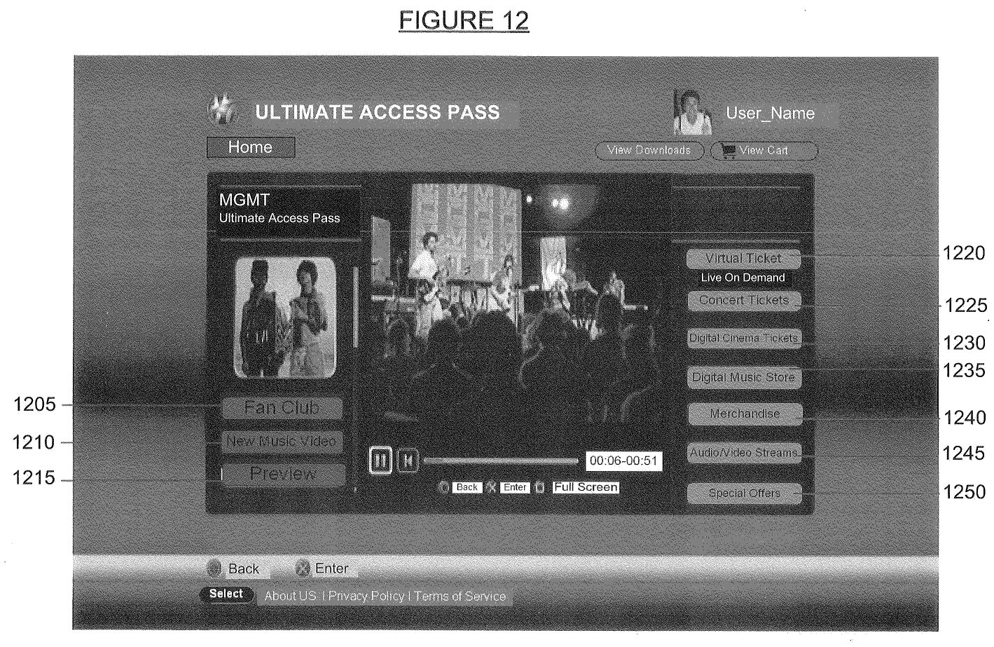

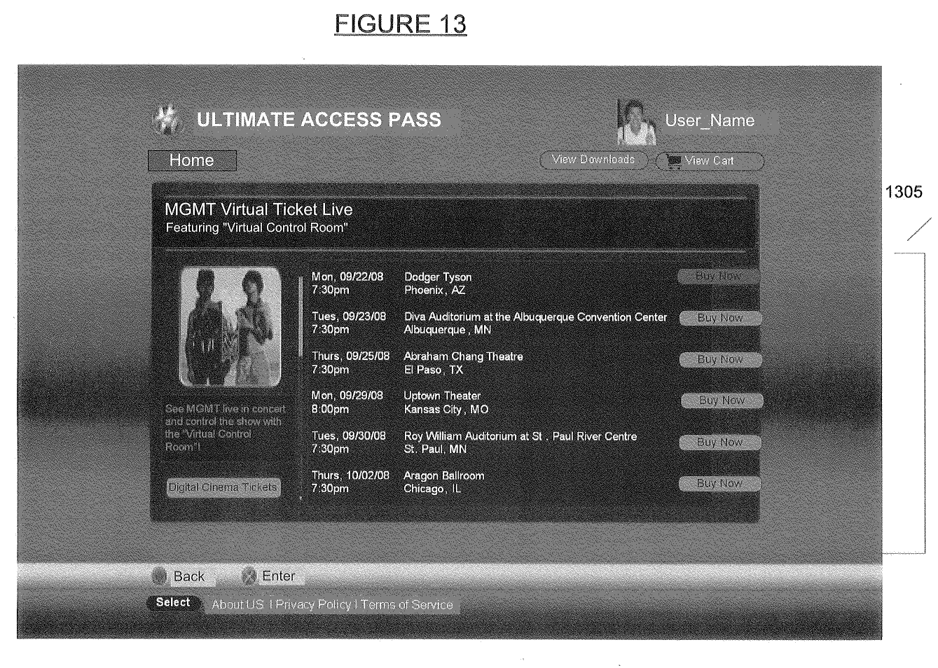

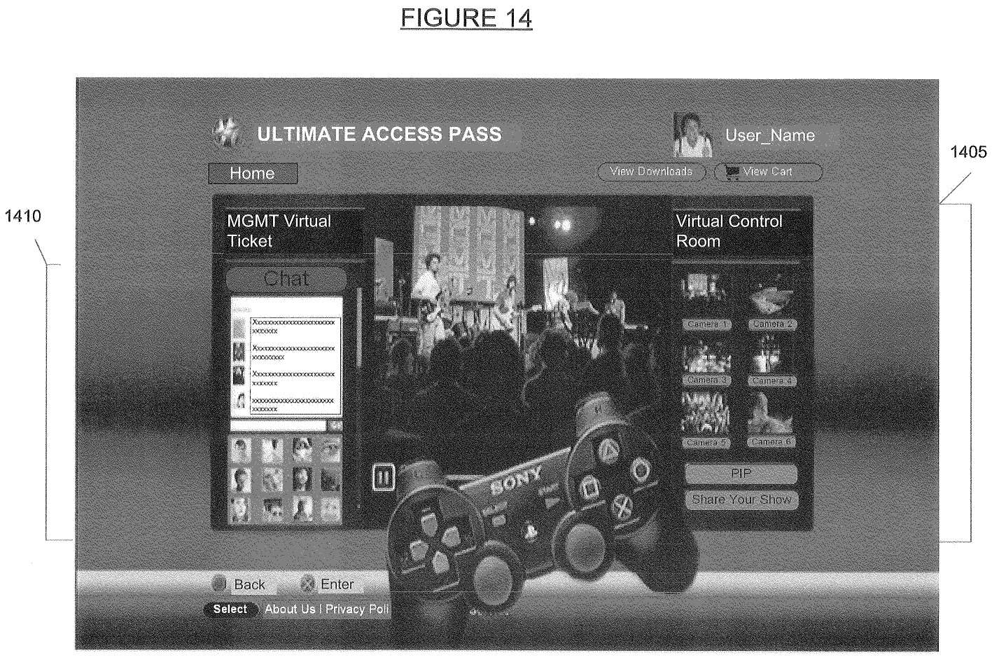

If the authorization application 305 determines that the party is a user (e.g., individual, family, group using a computer who wishes to view content), the process moves to 715. In 715, the user is allowed to browse and choose a particular entity of interest (e.g., artist, band, team, event). For example, in FIG. 10, the user can browse multiple entities of interest represented by various icons 1005. In another embodiment, the entities of interest could be represented by words, links, thumbprints, etc. In 720, the user is allowed access to a Web page related to the entity of interest chosen. For example, if the user chooses MGMT as the entity of interest in FIG. 11, a picture and description of MGMT can be illustrated. If the user then chooses GO 1105 on the MGMT Web page, the user could be brought to FIG. 12, which illustrates various MGMT content available to the user. The user is allowed access to free material and/or products and/or services for sale. The free material, products, and services can include, but are not limited to: fan club info 1205 (e.g., a link or links to fan clubs), preview info 1215 (e.g., audio and/or video of a new song), new music info 1210 (e.g., information on new CDs, new songs, etc.), virtual tickets 1220 (e.g., a code to provide access to one or more concerts), concert tickets 1225 (e.g., a ticket to a live concert), digital cinema tickets 1230 (e.g., a ticket to a digital concert held at a particular venue such as a cinema), digital music store 1235 (e.g., downloadable songs, albums, video), merchandise 1240 (e.g., merchandise related to the band), audio/video streams 1245 of pre-recorded audio and/or video recordings, and special offers 1245 (e.g., see example listed above with respect to the explanation of 750). If the user chooses virtual tickets 1220, the user can be taken to various dates 1305 for MGMT concerts as shown in FIG. 13, and the user can choose which concert he/she wishes to buy and view. The user can view the event in real-time, or download it for later viewing. In 725, in some embodiments, the user is able to customize the camera positions of the accessed material. For example, if a user is accessing a past or present concert, the user can customize which camera position he/she is interested in. For example, if a user chooses a particular MGMT concert illustrated on FIG. 13, the user is allowed to view that concert and can choose various camera position options 1405 as shown in FIG. 14. Note that FIG. 14 also illustrates a chat room 1410 that can be taking place while the user views the concert with other fans. In 730, the user is billed and/or the user's activity is tracked. For example, the navigational behavior of a user can be tracked and reported back to server 110 for analysis.

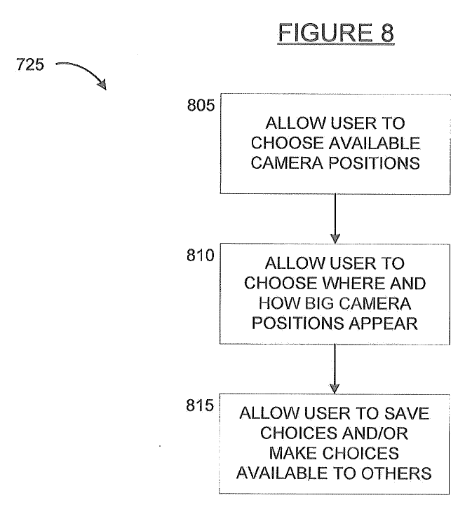

FIG. 8 illustrates details of method 725, which allowing users to choose to view various camera angles captured by different cameras at various locations, according to one embodiment. In 805, the user can choose which of the available camera positions to view. The camera positions can include, but are not limited to: on-stage positions (e.g., position 1), guitar tech/soundboard locations (e.g., positions 2 and 3), backstage/locker room locations (e.g., positions 4 and 5), a location where the camera is focused on a single on-stage participant (e.g., position 6), a location from a participant's point of view looking out into a room (e.g., position 7), eagle eye or overhead views from within the venue (e.g., position 8), one of many fixed locations within the audience (e.g., position 9), and a dedicated camera for on-site reporter(s) (e.g., position 10). In 810, the user can choose to where and how big to view the camera positions on certain areas of the screen. For example, a user could choose to view camera positions 1 and 2 in the top portion of the screen, and camera positions 3 and 4 as small windows at the bottom of the screen. As another example, the user could choose camera position 1 to appear on the whole screen, and camera position 4 and 5 to appear as a picture-in-picture (PIP) at the top right of the screen. It should be noted that in some embodiments, the user could crop the particular view of the camera position. For example, the user could choose to view an enlarged portion of only the soundboard on a soundboard location view. In 815, the user can choose to share his camera position choices with others by choosing the “share your show” option. The user could then link to a group of friends or a chat room and show them his choices for how the camera positions would appear.

For example, if a user wishes to access camera positions 1, 7 and 9, the user would choose those options on a user interface 125 GUI such as that provided in FIG. 14. The camera positions would be communicated to the user interface 125 through the digital software management application 245 that can contain a list of content. The user interface 125 would then communicate those choices to the server 110. Assuming the user has already been authorized by the authorization application 305, the user's choices of camera positions would be communicated to the POP application 315. The user's choices of camera positions would be communicated through the router 350, firewall 345, and propagation application 340, to the digital data storage application 335 which would have a series of database records, each record representing one camera position option. If an event is being shown live, the user could be directed to streaming content representing the various camera positions the user has chosen to access. These user choices could appear on a user interface 125 such as that provided in FIG. 14. If a user chooses to view one or more of the camera positions, the user could be taken to a link that directs the user to streaming content from the chosen camera position(s). The user choices could also appear as a menu of text and/or graphic image choices, represented literally or abstractly so as to denote to user that each individual entry is a unique camera position. The physical graphical layout of these menus may change for each event. The user interface 125 can also contain a series of text or graphic menu items controlling the display variables for the camera positions (and can be set globally to govern all camera positions or be manually set for individual positions). The display variables include, but are not limited to: size of viewing area for camera position(s), resolution of playback, location of camera position on display, and default camera position to display.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments.

In addition, it should be understood that the figures described above, which highlight the functionality and advantages of the present invention, are presented for example purposes only. The architecture of the present invention is sufficiently flexible and configurable, such that it may be utilized in ways other than that shown in the figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A computerized method of providing access to at least one live event over a network, comprising:
receiving by at least one server, over the network, at least one request to access the at least one live event from at least one user utilizing at least one device;
providing by the at least one server, over the network, at least two different camera position views of the requested at least one live event to the at least one user utilizing the at least one device;
receiving by the at least one server, over the network, a request to access at least one of the at least two different camera position views of the requested at least one live event from the at least one user; and
providing the requested at least one camera position view to the at least one user utilizing the at least one device.

2. The method of claim 1, wherein at least one past event can also be accessed.

3. The method of claim 1, wherein the at least one live event comprises:
at least one sporting event;
at least one concert event; or
any combination thereof.

4. The method of claim 2, wherein multiple related events can be accessed.

5. The method of claim 4, wherein the multiple events comprise:
a series of sporting events;
a series of concerts; or
any combination thereof.

6. The method of claim 1, wherein the camera positions comprise:
at least one on-stage position;
at least one guitar tech position;
at least one soundboard position;
at least one backstage position;
at least one locker room position;
at least one overhead view position;
at least one audience position; or
at least one on-site reporter position; or
any combination thereof.

7. The method of claim 2, wherein products and/or services related to the live event and/or the at least one past event can be provided.

8. The method of claim 7, wherein the products and/or services comprise:
fan club information;
avatar information;
preview information;
virtual ticket information;
digital cinema ticket information;
news information;
digital music store products; or
merchandise; or
any combination thereof.

9. A computerized system for providing access to at least one live event over a network, comprising:
at least one server coupled to at least one network;
at least one user terminal coupled to the at least one network;
at least one application coupled to the at least one server and/or the at least one user terminal, wherein the at least one application is configured for:
receiving by at least one server, over the network, at least one request to access the at least one live event from at least one user utilizing at least one device;
providing by the at least one server, over the network, at least two different camera position views of the requested at least one live event to the at least one user utilizing the at least one device;
receiving by the at least one server, over the network, a request to access at least one of the at least two different camera position views of the requested at least one live event from the at least one user; and
providing the requested at least one camera position view to the at least one user utilizing the at least one device.

10. The system of claim 9, wherein at least one past event can also be accessed.

11. The system of claim 9, wherein the at least one live event comprises:
at least one sporting event;
at least one concert event; or
any combination thereof.

12. The system of claim 10, wherein multiple related events can be accessed.

13. The system of claim 12, wherein the multiple events comprise:
a series of sporting events;
a series of concerts; or
any combination thereof.

14. The system of claim 9, wherein the camera positions comprise:
at least one on-stage position;
at least one guitar tech position;
at least one soundboard position;
at least one backstage position;
at least one locker room position;
at least one overhead view position;
at least one audience position; or
at least one on-site reporter position; or
any combination thereof.

15. The system of claim 10, wherein products and/or services related to the live event and/or the at least one past event can be provided.

16. The system of claim 15, wherein the products and/or services comprise:
fan club information;
avatar information;
preview information;
virtual ticket information;
digital cinema ticket information;
news information;
digital music store products; or
merchandise; or
any combination thereof.

17. The method of claim 1, wherein identification information tied to the at least one user is tied to all of the at least one user's devices so that the at least one user can access any of the at least one user's authorized content on any of the at least one user's devices.

18. The method of claim 1, wherein access is also provided to at least one digital store specific to at least one entity.

19. The method of claim 1, wherein different tiers of membership services are provided to the at least one user.

20. The method of claim 1, wherein the at least one live event is at least one auction.

21. The method of claim 1, wherein the at least one live event is at least one talk show.

22. The method of claim 1, wherein at least one social network is tied to the at least one live event.

23. The method of claim 1, wherein the at least one device comprises:
at least one television;
at least one computer;
at least one video game console;
at least one mobile device;
at least one Internet-accessible device; or
at least one Blue Ray device; or
any combination thereof.

24. The method of claim 1, wherein at least one account of the at least one user can be personalized.

25. The system of claim 9, wherein identification information tied to the at least one user is tied to all of the at least one user's devices so that the at least one user can access any of the at least one user's authorized content on any of the at least one user's devices.

26. The system of claim 9, wherein access is also provided to at least one digital store specific to at least one entity.

27. The system of claim 9, wherein different tiers of membership services are provided to the at least one user.

28. The system of claim 9, wherein the at least one live event is at least one auction.

29. The system of claim 9, wherein the at least one live event is at least one talk show.

30. The system of claim 9, wherein at least one social network is tied to the at least one live event.

31. The system of claim 9, wherein the at least one device comprises:
at least one television;
at least one computer;
at least one video game console;
at least one mobile device;
at least one Internet-accessible device; or
at least one Blue Ray device; or
any combination thereof.

32. The system of claim 9, wherein at least one account of the at least one user can be personalized.
